(19) United States
(12) Patent Application Publication
(10) Pub. No.: US 2009/0232181 A1
(43) Pub. Date: Sep. 17, 2009

(54) SYSTEMS AND METHODS FOR CONTROLLING THE ELECTRODE POSITION IN AN ARC FURNACE

(76) Inventor: Pedro Bianchi di Carcano, Walton, KY (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 12/048,441

(22) Filed: Mar. 14, 2008

(51) Int. Cl. H05B 7/148

(52) U.S. Cl. 373/105

(57) ABSTRACT

Embodiments of a system for controlling the position of an electrode in an arc furnace comprise an arc furnace comprising a molten bath and slag disposed over the molten bath, wherein the slag contacts the molten bath at an interface. The system further comprises an electrode comprising a lower tip, wherein the electrode is configured to deliver current by disposing the lower tip of the electrode below the upper surface of the slag. The current is substantially directed through the slag to the interface. The system also comprises a control system configured to determine the position of the lower tip of the electrode relative to the upper surface of the slag based on harmonic frequencies associated with the current, wherein the lower tip position relative to the upper surface of the slag correlates to the harmonic frequencies.

### BACKGROUND

Embodiments of the present invention are generally directed to systems utilizing arc furnaces in steel production, and are specifically directed to the control systems used to control the electrode position inside the arc furnace.

### SUMMARY

Electric arc furnaces (e.g. DC arc furnaces and AC arc furnaces) are widely used devices in the production of steel. As would be familiar to one of ordinary skill in the art, direct current (DC) arc furnaces utilize a single electrode, which generate an electric arc to heat the material therein. The present inventors have recognized the importance of positioning the lower tip of the electrode below the upper surface of the slag, because that ensures that the electric arc is submerged inside the slag. Properly submerging the electric arc maximizes the power that the electric arc can deliver without damaging the furnace walls. As a result, the present invention is directed to a control system configured to control the position of the lower tip of the electrode to maximize the power of the electric arc without damaging the furnace.

According to one embodiment, a system for controlling the position of an electrode in an arc furnace is provided. The system comprises an arc furnace comprising a molten bath and slag disposed over the molten bath, wherein the slag contacts the molten bath at an interface. The system also comprises an electrode having a lower tip configured to be disposed below the upper surface of the slag. The current forms an electric arc between the upper surface of the slag and the interface. The system also comprises a control system configured to determine the position of the lower tip of the electrode relative to the upper surface of the slag based on harmonic frequencies associated with the current, wherein the lower tip position in relation to the slag surface correlates to the harmonic frequencies.

According to further embodiments, the control system may comprise a sensor configured to detect the current and output harmonic frequencies corresponding to the current, and a filtering device in communication with the sensor and configured to output only the harmonic frequencies which fall within a predefined filter range. The control system may also comprise a digital processor in communication with the filtering device configured to determine the position of the lower tip of the electrode relative to the upper surface of the slag based on harmonic frequencies associated with the current.

According to yet another embodiment, a method for controlling position of an electrode lower tip in an arc furnace is provided. The method comprises the steps of positioning the electrode tip below the upper surface of the slag, forming an electric arc directed by delivering current via the electrode to the upper surface of the slag, determining the position of the electrode lower tip relative to the upper surface of the slag by measuring harmonic frequencies associated with the current, wherein the position of the electrode lower tip relative to the upper surface of the slag correlates to the harmonic frequencies, and repositioning the lower tip of the electrode when the lower tip of the electrode is disposed above the upper surface of the slag or when a portion of the electrode in addition to the lower tip is submerged below the upper surface of the slag.

These and additional objects and advantages provided by the embodiments of the present invention will be more fully understood in view of the following detailed description, in conjunction with the drawings.

### BRIEF DESCRIPTION OF THE DRAWINGS

The following detailed description of specific embodiments of the present invention can be best understood when read in conjunction with the drawings enclosed herewith. The drawing sheets include:

FIG. 1 is a schematic view illustrating an arc furnace wherein the electrode lower tip is disposed below the upper surface of the slag according to one or more embodiments of the present invention; and

FIG. 2 is a schematic view illustrating an arc furnace wherein the electrode lower tip is disposed above the upper surface of the slag; and

FIG. 3 is a schematic view illustrating an arc furnace wherein the electrode lower tip is submerged below the upper surface of the slag.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION

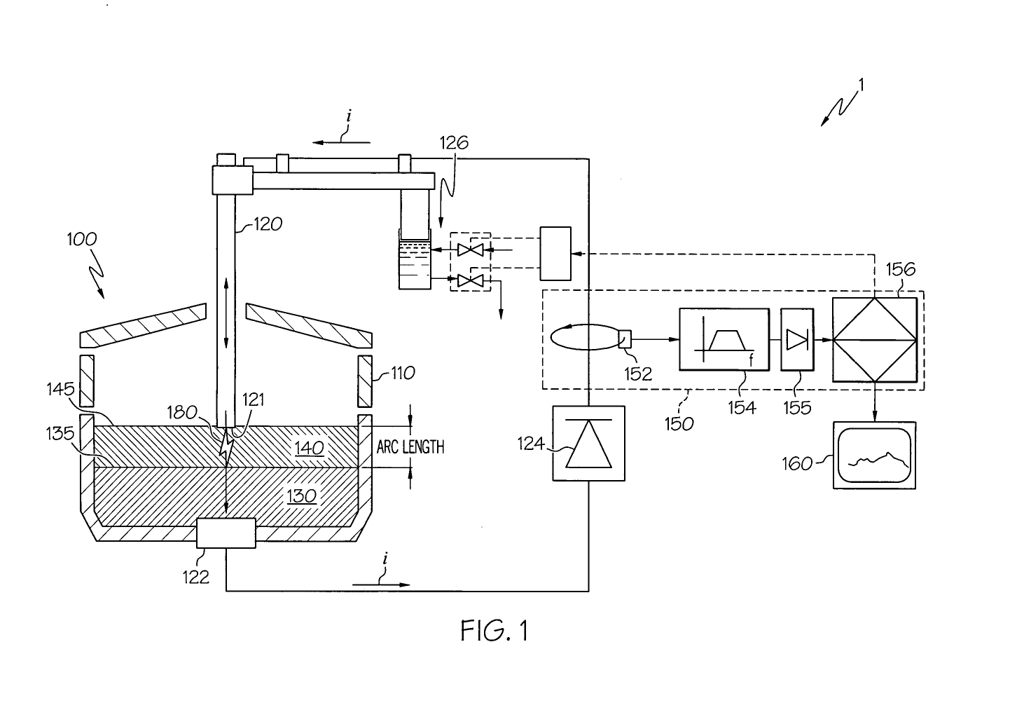

Referring to FIG. 1, an embodiment of a system 1 for controlling the position of an electrode 120 in an arc furnace 100 is illustrated. As shown, the arc furnace 100 is a reactor unit comprising materials (e.g., refractory brick) which can withstand high operation temperatures (e.g., temperatures well above 3000° F.). Although the illustrated embodiments of the figures depict DC furnaces, the arc furnace 100 may be a DC furnace or an AC arc furnace. Referring to FIG. 1, the DC arc furnace 100 comprises an electrode 120 disposed within the roof of the furnace 100. The electrode 120, which may comprise a consumable or a non-consumable electrode material, is coupled to any suitable power source familiar to one of ordinary skill in the art. Referring to the embodiment of FIG. 1, the power source may be a rectifier 124. As shown in FIG. 1, the current used to produce the electric arc 180 is delivered through the electrode 120, and the current is returned through a bottom electrode 122. In the FIG. 1 embodiment, the bottom electrode 122, which may comprise conductive rods, is positioned in the lower base of the furnace 100; however, other suitable locations for the bottom electrode 122 are contemplated herein.

During steelmaking, the arc furnace 100 comprises a molten bath 130 and slag 140 disposed over the molten bath 130. As shown, the slag 140 contacts the molten bath at an interface 135. In one embodiment, the molten bath 130 may comprise a molten metal such as liquid steel. As would be familiar to one of ordinary skill in the art, slag is the impurity produced when a metal component (ore or scrap) is smelted at high temperatures to improve the purity of the metal component. Despite being an impurity which is eventually removed, the slag may be used to contain the arc power required during steel production. The amount of slag may be altered via chemical additives, etc.

As shown in FIG. 1, the electrode 120 comprises a lower tip 121 which is disposed below the upper surface 145 of the slag 140. By disposing the lower tip 121 just below the upper surface 145 of the slag 140, an electric arc 180 is created which extends from the upper surface 145 of the slag 140 to the interface 135 of the slag 140 and the molten bath 130. Consequently, in the embodiment of FIG. 1, the distance from the lower tip 121 of the electrode 120 to the interface 135 is the arc length. By ensuring the electric arc 180 is disposed inside the slag 140, the heat transfer of the electric arc is substantially maximized.

Referring again to FIG. 1, when the lower tip 121 is positioned just below the upper surface 145 of the slag forming material 140, the height of the slag and the arc length are substantially the same. Because the voltage required to produce the arc (V_{arc}) is known at any given point, maintaining the lower tip 121 just below the upper surface 145 of the slag 140 enables simple computation of the slag height. The arc length (L_{arc}) is defined by the equation L_{arc}=k*V_{arc}, wherein k is a constant and V_{arc} is known. Since the slag height and the arc length are substantially equal when the lower tip 121 is positioned just below the upper surface 145 of the slag 140, calculating the arc length (L_{arc}) via the above equation will also yield the slag height.

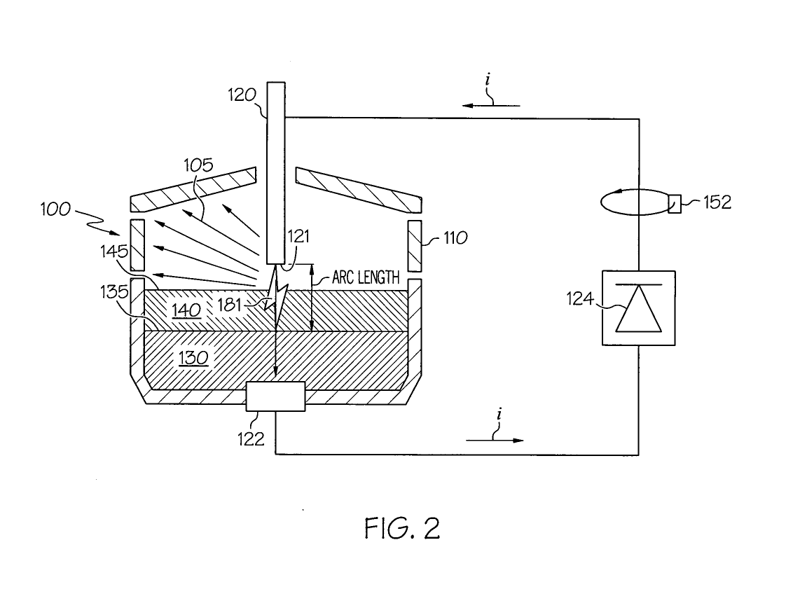

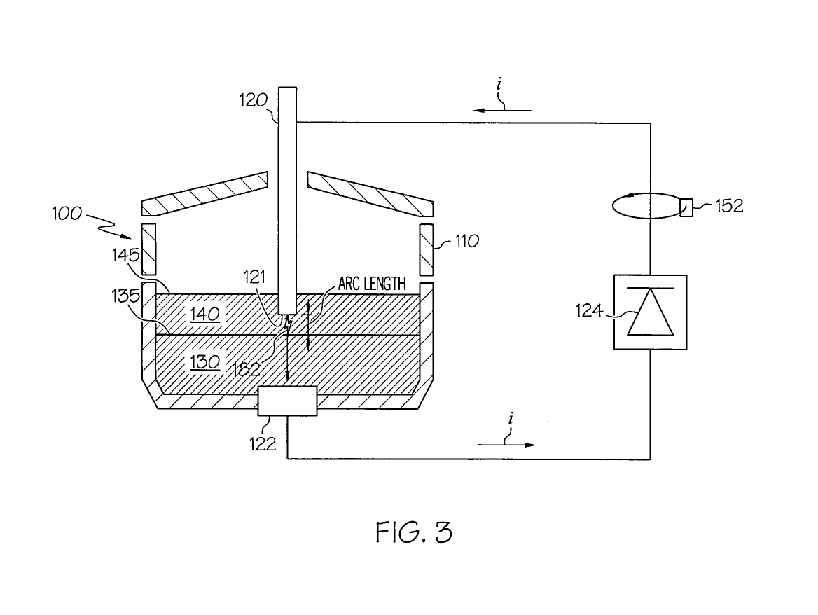

If the electrode lower tip 121 is not positioned just below the upper surface 145 of the slag 140 as in FIG. 1, the arc furnace 100 is operating in a non-optimal inefficient manner. FIGS. 2 and 3 illustrate two scenarios where an arc furnace is running non-optimally. Referring to FIG. 2, the lower tip 121 of the electrode 120 is positioned above the upper surface 145 of the slag 140. As a result, the electric arc 181, which begins at the lower tip 121 of the electrode 120, is not just delivered to the molten bath 130. Plasma 105 from the electric arc 181 is also delivered to the walls 110 of the arc furnace 100, thereby wasting a portion of the heat capacity of the electric arc 181. Additionally, the plasma 105 also may prematurely degrade the walls 110 of the arc furnace 100.

Referring to FIG. 3, more than just the lower tip 121 of the electrode 120 is submerged below the upper surface 145 of the slag 140. This is non-optimal because the electric arc 182 is not operating at full power. The power of the electric arc (P_{arc}) is defined by the following equation: P_{arc}=V_{arc}*I=k*L_{arc}*I, wherein I is the current. Utilizing the power equation, increasing the arc length (L_{arc}) while maintaining the same current increases the power (P_{arc}) produced by the electric arc. If more than the lower tip 121 of the electrode 120 is submerged below the upper surface 145 of the slag 140, the arc length (L_{arc}) is decreased, and thus the power produced by the electric arc 182 is also decreased. By disposing the lower tip 121 of the electrode 120 just below the upper surface 145 of the slag 140 as shown in FIG. 1, the arc furnace maximizes arc length and power, without damaging or prematurely degrading the furnace walls 110.

Referring to FIG. 1, the system 1 utilizes a control system 150 configured to determine the position of the lower tip 121 of the electrode 120 relative to the upper surface 145 of the slag 140, and ensure the lower tip 121 is properly positioned. The control system 150 detects harmonic frequencies associated with the current and compares the harmonic frequencies to a predefined filter range. Multiple predefined filter ranges are contemplated based on the processing conditions. The present inventor has recognized via experimentation and mathematical analysis (e.g. Fourier analysis) that a range of about 100 to about 140 Hz is a suitable predefined filter range. If the harmonic frequency value falls within the predefined filter range, the control system 150 knows that the lower tip 121 of the electrode 120 needs to be repositioned. After detecting the position of the lower tip 121 of the electrode 120 relative to the slag interface 145, the control system 150, in further embodiments, is operable to instruct that the electrode should be repositioned.

The control system 150 comprises multiple components familiar to one of ordinary skill in the art. Referring to FIG. 1, the control system 150 may comprise a sensor 152 (e.g. a magnetic field sensor) configured to detect the current. In one embodiment, the magnetic field sensor 152 is a Hall magnetic field sensor. As shown in the embodiment of FIG. 1, the magnetic field sensor 152 detects the electric current and outputs harmonic frequencies corresponding to the current. The magnetic field sensor 152 outputs these harmonic frequencies to a filtering device 154. Although the control system of FIG. 1 utilizes an analog band pass filter or a digital band pass filter for its filtering device 154, many other suitable filtering devices 154 are contemplated herein. Optionally, the control system 150 may comprise a rectifier 155 downstream of the filtering device 154. The rectifier 155 is operable to convert an AC signal from the filtering device to a DC signal. The filtering device 154 only outputs harmonic frequencies which fall within a predefined filter range (e.g., about 100 to about 140 Hz), and purges any values not within that range. As stated above the level of harmonic frequencies within the predefined filter range may indicate the relative position of the lower electrode tip 120 in relation to the slag surface 145. For example, the harmonic frequencies may indicate that the lower tip 121 of the electrode 120 is above the upper surface 145 of the slag 140 as shown in FIG. 2, or that a portion of the electrode 120 in addition to the lower tip 121 is submerged below the upper surface 145 of the slag 140 as shown in FIG. 3.

Referring again to FIG. 1, the outputted harmonic frequencies from the filtering device 154, are then delivered to a digital processor 156. The digital processor 156 may comprise a programmable logic controller, a peripheral interface controller, a microprocessor, or another suitable device familiar to one of ordinary skill in the art. The digital processor 156 is configured to receive a signal proportional to the amplitude of the filtered harmonic frequencies, and transforms this signal into a new signal or function that indicates whether the electrode needs to be raised or lowered. In further embodiments, it is contemplated that the digital processor 156 direct communicates with the magnetic field sensor 152, and is operable to perform the functions of the filtering device 154 without utilizing a rectifier 155.

Referring to FIG. 1, the digital processor 156 is also configured to reposition the lower tip 121 of the electrode 120. In one embodiment, the digital processor 156 is configured to provide information to an operator interface 160. As used herein, the “operator interface” 160 refers to a suitable user interface or screen operable to display information to a user or operator regarding the position of the lower tip 121 of the electrode 120 in relation to the upper surface of the slag. The operator or the digital processor may raise or lower the electrode 120 using a suitable electrode repositioning device 126. Referring to the embodiment of FIG. 1, the electrode positioning device 126 comprises an arm configured to raise or lower the electrode 120, for example, an arm fixed to a hydraulic mast configured to be lifted or lowered through a hydraulic column controlled with hydraulic valves. The electrode positioning device 126 may be actuated by the operator, or may be actuated automatically by instruction provided by the digital processor 156. In an alternative embodiment, the operator may increase or decrease the carbon injection rates to raise or lower the height of the slag in order to ensure the lower tip 121 is disposed below the upper surface 145 of the slag 140.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A system for controlling the position of an electrode in an arc furnace, the system comprising:
an arc furnace comprising a molten bath and slag disposed over the molten bath, wherein the slag contacts the molten bath at an interface;
an electrode comprising a lower tip, wherein the electrode is configured to deliver current by disposing the lower tip of the electrode below the upper surface of the slag, the current being configured to form an electric arc between the upper surface of the slag and the interface; and
a control system configured to determine the position of the lower tip of the electrode relative to the upper surface of the slag based on harmonic frequencies associated with the current, wherein the lower tip position relative to the upper surface of the slag correlates to the harmonic frequencies.

2. The system of claim 1 wherein the control system is configured to instruct that the electrode should be repositioned when the lower tip of the electrode is disposed above the upper surface of the slag or when a portion of the electrode in addition to the lower tip is submerged below the upper surface of the slag.

3. The system of claim 2 further comprising an electrode positioning device operable to adjust the position of the electrode in response to instructions by the control system.

4. The system of claim 3 wherein the electrode positioning device comprises a hydraulic arm configured to raise or lower the electrode.

5. The system of claim 2 further comprising an operator interface operable to display an index of the slag volume and the information received from the control system.

6. The system of claim 1 wherein the control system comprises a sensor configured to detect the current.

7. The system of claim 6 wherein the sensor is a magnetic field sensor.

8. The system of claim 1 wherein the control system further comprises a filtering device configured to output only the harmonic frequencies which fall within a predefined filter range.

9. The system of claim 8 wherein the filtering device is a band pass filter.

10. The system of claim 8 wherein the predefined filter range is about 100 Hz to about 140 Hz.

11. The system of claim 8 further comprising a digital processor in communication with the filtering device.

12. The system of claim 11 wherein the digital processor is a programmable logic controller.

13. The system of claim 1 further comprising a power source coupled to the electrode.

14. The system of claim 13 wherein the power source is a rectifier.

15. A system for controlling the position of an electrode in an arc furnace, the system comprising:
an arc furnace comprising a molten bath and slag disposed over the molten bath, wherein the slag contacts the molten bath at an interface;
an electrode comprising a lower tip, wherein the electrode is configured to deliver current by disposing the lower tip of the electrode below the upper surface of the slag, the current being configured to form an electric arc between the upper surface of the slag and the interface;
a sensor configured to detect the current;
a filtering device in communication with the sensor and configured to output only the harmonic frequencies which fall within a predefined filter range; and
a digital processor in communication with the filtering device configured to determine the position of the lower tip of the electrode relative to the upper surface of the slag based on harmonic frequencies associated with the current, wherein the lower tip position relative to the upper surface of the slag correlates to the harmonic frequencies.

16. The system of claim 15 wherein the digital processor is configured to instruct that the electrode should be repositioned when the lower tip of the electrode is disposed above the upper surface of the slag or when a portion of the electrode in addition to the lower tip is submerged below the upper surface of the slag.

17. The system of claim 15 wherein the predetermined filter range is about 100 Hz to about 140 Hz.

18. A method for controlling position of an electrode lower tip in an arc furnace, wherein the arc furnace comprises a molten bath and slag disposed over the molten bath, the method comprising:
positioning the electrode tip below the upper surface of the slag;
forming an electric arc by delivering current via the electrode to the upper surface of the slag;
determining the position of the electrode lower tip relative to the upper surface of the slag by measuring harmonic frequencies associated with the current, wherein the position of the electrode lower tip relative to the upper surface of the slag correlates to the harmonic frequencies; and
repositioning the lower tip of the electrode when the lower tip of the electrode is disposed above the upper surface of the slag or when a portion of the electrode in addition to the lower tip is submerged below the upper surface of the slag.

19. The method of claim 18 further comprising filtering out harmonic frequencies that lie outside of a predetermined filter range.

20. The method of claim 18 wherein the predetermined filter range is about 100 Hz to about 140 Hz.
